(19) United States
(12) Patent Application Publication
(10) Pub. No.: US 2009/0148194 A1
(43) Pub. Date: Jun. 11, 2009

(54) Toner cartridge

(75) Inventor: Kenneth Yuen, San Gabriel, CA (US)

Correspondence Address: MERCHANT & GOULD PC, P.O. BOX 2903, MINNEAPOLIS, MN, 55402-0903, US

(73) Assignee: Master Ink Company, Ltd.

(21) Appl. No.: 11/999,697

(22) Filed: Dec. 5, 2007

(51) Int. Cl. G03G 15/08

(52) U.S. Cl. 399/263

(57) ABSTRACT

The present disclosure relates to a toner cartridge with a toner level detector mechanism. The toner level detector mechanism according to the present disclosure includes a construction that is easy to assemble and manufacture.

### TECHNICAL FIELD

The present disclosure relates to a toner cartridge for use in an electronic image forming apparatus.

### BACKGROUND OF THE INVENTION

Electronic image forming apparatuses (e.g., printers) have more recently been configured to identify when the toner cartridge of the printer needs to be replaced. According to one known system the electronic image forming apparatus is configured to measure the length of time it takes for a toner agitator within a toner cartridge to make it through a portion of its rotation. The relative time that the agitator takes to move through a portion of its rotation is used to determine if the toner cartridge is sufficiently full or is ready to be replaced.

FIG. 1 is a schematic illustration of a toner cartridge 1 in an image forming apparatus that is configured to determine whether the toner cartridge 1 needs to be replaced. The determination is based on the switching frequency of the sensor 8. In the illustrated system, a magnet 7 provided on a link 5 inside the housing of the toner cartridge 1 cooperates with a magnet 9 of the sensor 8 to cause the sensor 8 to switch its status. The rotary motion of the rotary member 4 stirs the toner 2, which moves the link 5 within the vertical tube at the top side of the housing 3. Other prior art cartridges are disclosed in U.S. Pat. Nos. 6,892,036 and 7,076,180, which are both incorporated by reference herein in their entirety.

The present disclosure relates to an improved toner cartridge that is easy to manufacture and is reliable.

### SUMMARY OF THE INVENTION

The present disclosure relates to a toner cartridge with a toner level detector mechanism. The toner level detector mechanism according to the present disclosure includes a construction that is easy to assemble and manufacture.

### BRIEF DESCRIPTION OF THE DRAWINGS

FIG. 1 is a schematic view of a portion of a prior art toner cartridge and electronic image forming apparatus;

FIG. 2 is a perspective view of a cartridge according to the present disclosure;

FIG. 3 is a top view of the cartridge of FIG. 2;

FIGS. 4A-D are cross-sectional views along line 4-4 of FIG. 3;

FIG. 5 is a schematic perspective view of some of the features shown in FIGS. 4A-D;

FIGS. 6A-B are side views of the coupling member of the cartridge of FIG. 2;

FIGS. 7A-B are side views of the reciprocating member of the cartridge of FIG. 2;

FIGS. 8A-D are cross-sectional views of a first alternative embodiment of the cartridge of FIG. 2; and

FIGS. 9A-D are cross-sectional views of a second alternative embodiment of the cartridge of FIG. 2.

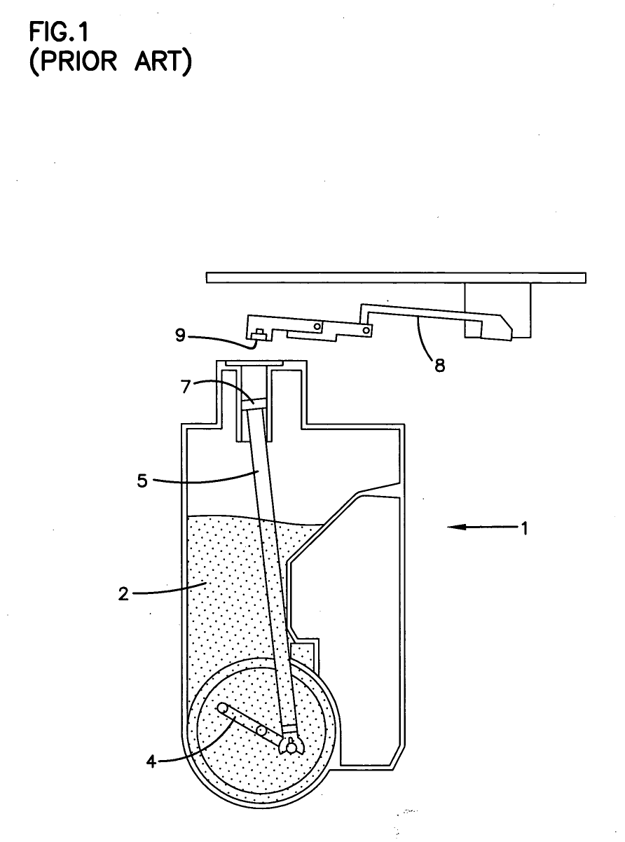

### DETAILED DESCRIPTION OF THE PREFERRED EMBODIMENT

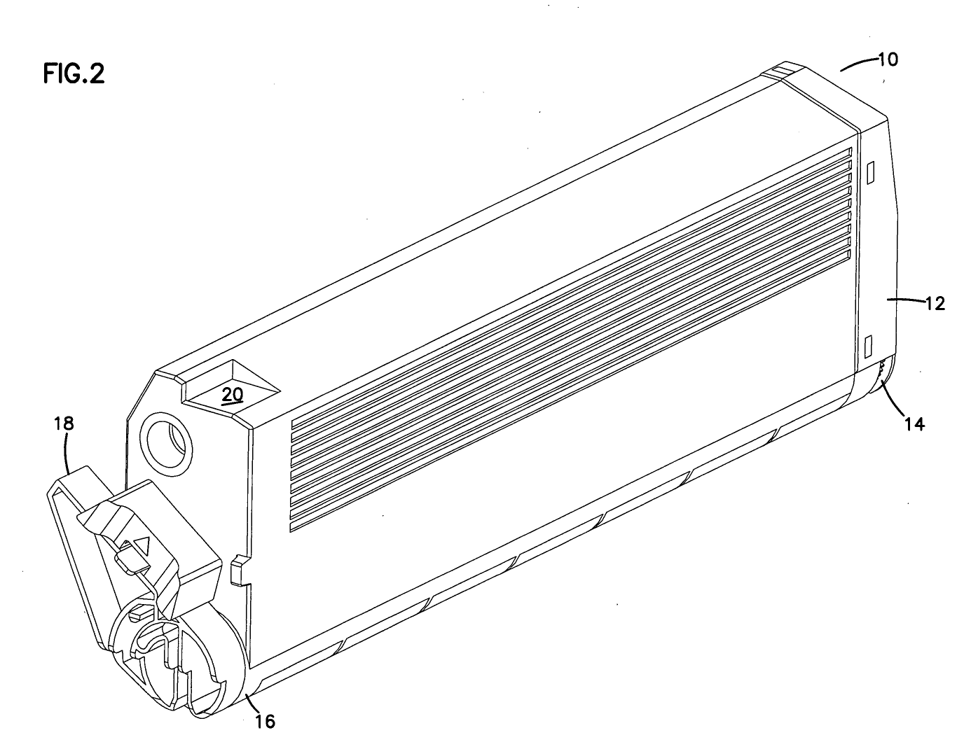

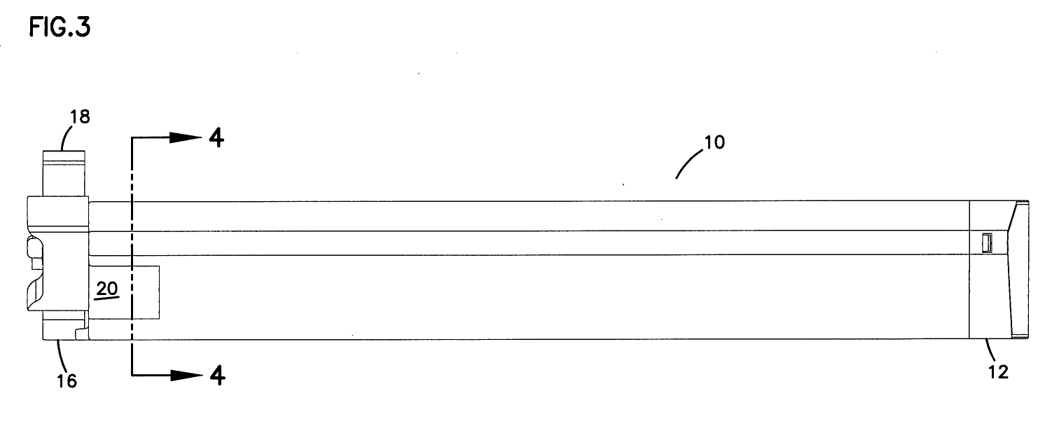

Referring to FIGS. 2 and 3, an embodiment of a toner cartridge 10 according to the present disclosure is shown. The toner cartridge 10 includes a first end portion 12 which includes a geared agitator drive mechanism 14, and a second end portion 16 which includes a shutter lever 18 and a sensor window 20.

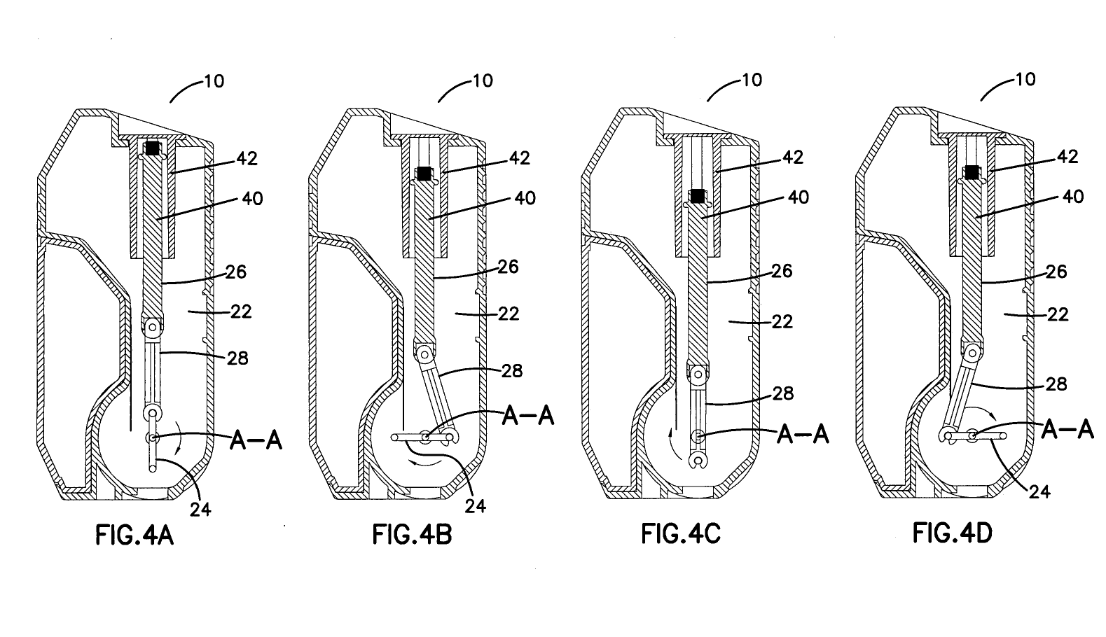

Referring to FIGS. 4A-D, cross-sectional views of the toner cartridge 10 along line 4-4 of FIG. 3 are shown with the toner level detector mechanism 22 shown in different positions. FIG. 4A depicts the level detector mechanism 22 with the toner agitator 24 in the lower position, FIGS. 4B and 4D depict the level detector mechanism 22 with the agitator 24 in an intermediate position, and FIG. 4C depicts the agitator 24 in an upper position.

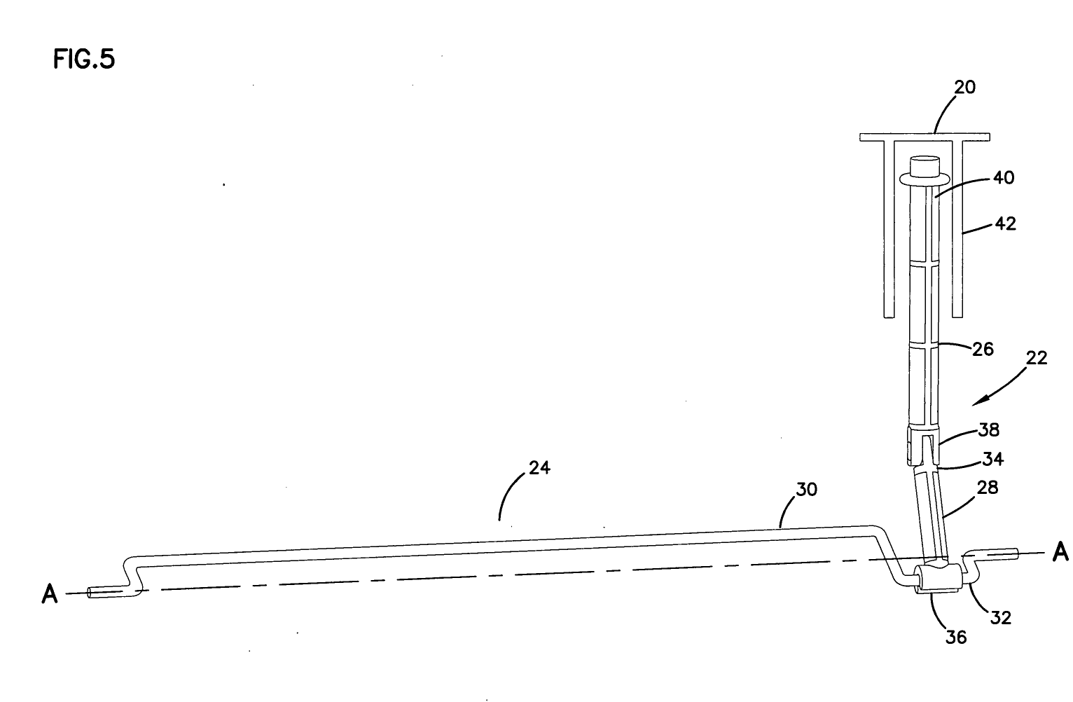

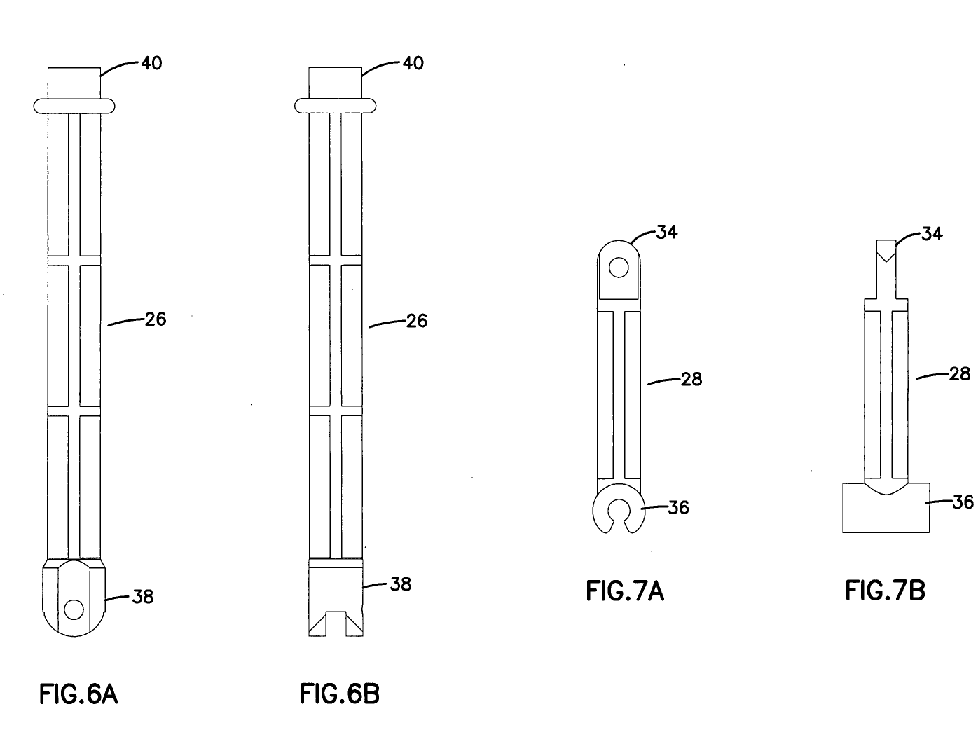

Referring generally to FIGS. 4A-7B, the reciprocating member 26 is shown connected to the agitator 24 via a coupling member 28. The agitator 24 includes a shaft portion 30 that is offset from the rotational axis A-A (FIG. 5). The reciprocating member 26 also includes an offset crank portion 32 in the second end portion 16 of the cartridge 10 (FIG. 5). In the depicted embodiment, the shaft portion 30 and the crank portion 32 are offset from the rotational axis in the opposite direction. A coupling member 28 is shown pivotally connected to the crank portion 32 of the agitator 24 and pivotally connected to the reciprocating member 26. In the depicted embodiment the crank portion 32 is offset from the rotational axis a distance that is less than the offset of the shaft portion 30. In one embodiment the offset of the crank portion 32 is between ⅛ to about ½ inches (e.g., ¼ to about ⅓ of an inch) and the coupler is at least twice the length of the offset. It should be appreciated that many other configurations are also possible.

In the depicted embodiment, the first end 34 of the coupling member 28 is connected to the lower end 38 of the reciprocating member 26 via a pinned joint, and the second end 36 of the coupling member 28 is snap fitted over the crank portion 32 of the toner agitator. In the depicted embodiment, the upper end 40 of the reciprocating member 26 is slidably supported in a guide member 42. The guide member 42 keeps the upper end 40 of the reciprocating member 26 in the sensor window 20. In the depicted embodiment a magnetic material is provided on the upper end 40 of the reciprocating member 26. According to the depicted embodiment the coupling member 28 and reciprocating member 26 can be constructed of wide varieties of materials. In the depicted embodiment, the function of the toner level detector mechanism 22 does not necessarily depend on the structural members having particular flexing characteristics. This enables the use of a variety of different materials in the construction, resulting in a detector mechanism 22 that is easy to manufacture, reliable, and durable. In the depicted embodiment, both the reciprocating member 26 and the coupling member 28 are constructed of a polymeric material. Also according to the present disclosure, the toner level detector mechanism 22 does not need to be in a separate chamber from the toner supply chamber, allowing for more flexibility in the assembly and manufacture of the cartridge. The present disclosure provides a design that is reliable and easy to manufacture and assemble.

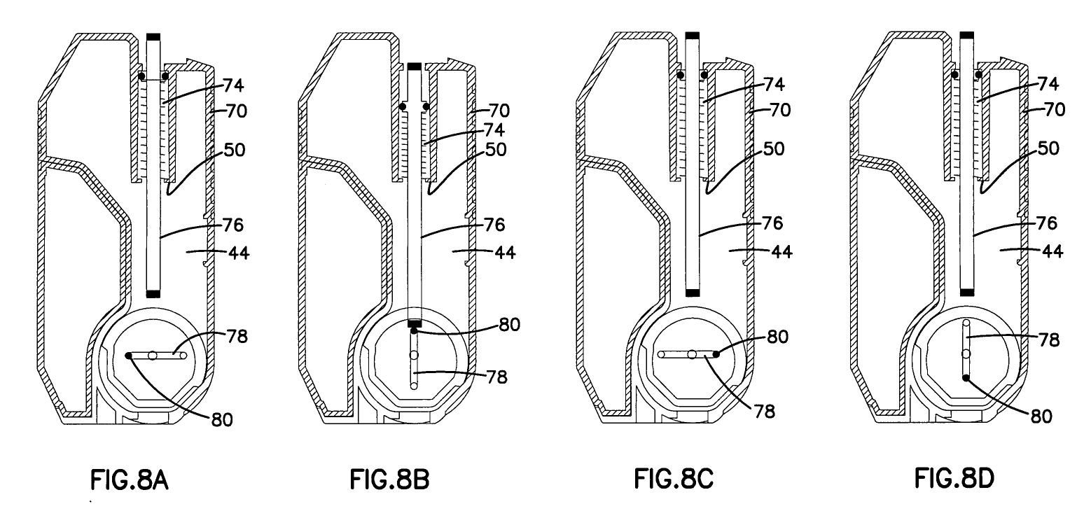

Referring to FIGS. 8A-D a cross-sectional view of a first alternative embodiment of the toner level detector mechanism is shown. The depicted embodiment incorporates features (e.g., the use of magnets to cause the reciprocating motion) that are disclosed in U.S. Pat. No. 7,076,180, which has been incorporated by reference. The present disclosure provides a housing configuration that enables a magnet driven toner level detector mechanism to be used without the need to have the mechanism housed in a chamber that is isolated from the toner supply chamber 44. In the depicted embodiment the housing 70 that houses the toner level detector mechanism is in fluid (e.g., air) communication with the toner supply chamber 44. The depicted single chamber configuration is advantageous over dual chamber configurations, as it can be easier to manufacture and assemble. According to the present disclosure, the toner supply chamber 44 includes a guide portion that includes toner deflectors 50 that prevent toner from jamming the detector mechanism. The guide portion also supports a spring 74 that biases the reciprocating member 76 normally upward. The reciprocating member 76 and the guide portion move relative to each other and are sealed to each other so that toner does not leak out of the cartridge. The agitator 78 is configured with a magnet 80 such that it pulls the reciprocating member 76 in a downward direction once during each rotation. It should be appreciated that many other alternative embodiments employing magnets are also possible.

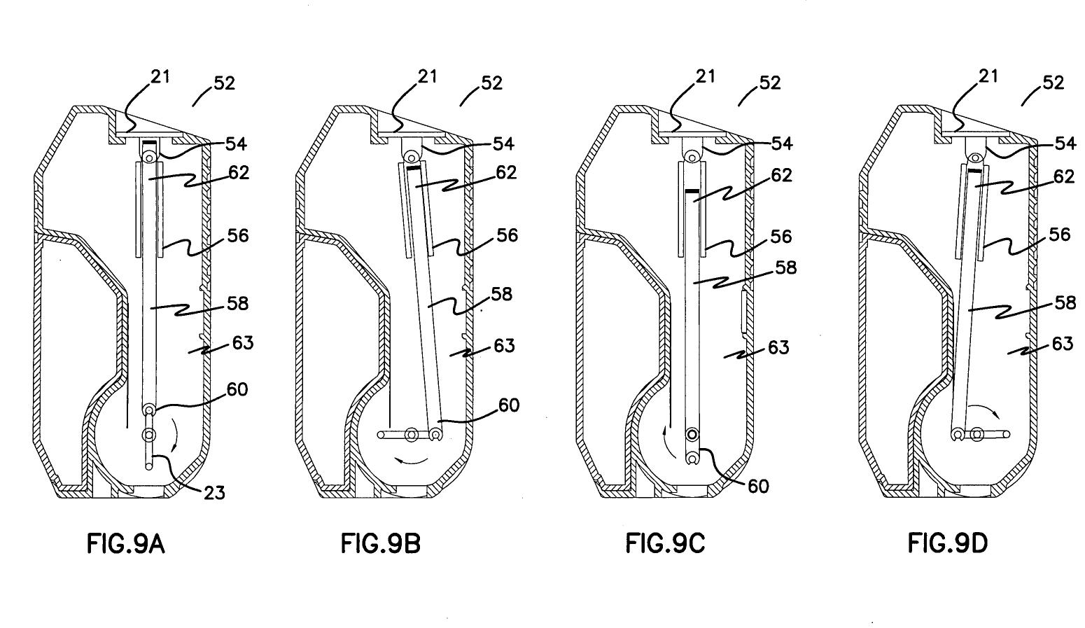

Referring to FIGS. 9A-D, a second alternative embodiment of a toner level detector mechanism 63 is shown. In the depicted embodiment, the toner cartridge 52 includes a pivot 54 below the window 21. The pivot 54 supports a shaft guide member 56 on the housing of the cartridge 52. A reciprocating shaft 58 includes a first end 60 pivotally attached to an agitator 23, and a second end 62 slidably engaged with the shaft guide member 56. In the depicted embodiment the shaft guide member 56 is tube shaped, and the second end 62 of the reciprocating shaft 58 is positioned within the tube.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A toner cartridge comprising:
a toner chamber;
an agitator configured to rotate within the toner chamber;
a coupler pivotably attached to the agitator; and
a reciprocally moving member pivotably connected to the coupler such that the reciprocally moving member reciprocates when the agitator rotates.

2. The cartridge of claim 1, wherein the coupler and reciprocally moving member are pinned together.

3. The cartridge of claim 1, wherein the coupler, agitator, and reciprocally moving member are arranged such that the reciprocally moving member remains substantially vertical as the agitator rotates.

4. The cartridge of claim 1, wherein the portion of the agitator that is connected to the coupler is offset from the rotational axis of the agitator by a length that is less than half of the length of the coupler.

5. The cartridge of claim 4, wherein the portion of the agitator that is connected to the coupler is offset from the rotational axis of the agitator by between about ¼ to about ⅓ inches.

6. The cartridge of claim 1, wherein the coupler is configured to snap over a portion of the agitator.

7. The cartridge of claim 1, further comprising a guide configured to slidably support an end of the reciprocally moving member.

8. A method of identifying when a toner cartridge should be replaced comprising:
connecting a toner agitator to a reciprocally moving member via a coupler, wherein the coupler is pivotally connected to a reciprocally moving member and an offset portion of an agitator.

9. A toner cartridge comprising:
a housing having a first chamber and a second chamber; a rotary member mounted in said first chamber and rotatable relative to said housing by an external rotary driving force; a first magnetized material fixedly fastened to said rotary member; an axial motion member mounted in said second chamber; and a second magnetized material fixedly provided at a bottom side of said axial motion member for acting with said first magnetized material to further force said axial motion member to reciprocate;
wherein the first and second chambers are in fluid communication with each other, and wherein a toner deflector portion is provided between the first and second chambers.

10. A toner cartridge comprising:
a toner chamber;
an agitator configured to rotate within the toner chamber;
a shaft guide member pivotally connected to the chamber; and
a reciprocating shaft including a first end pivotably attached to the agitator and a second end slidably engaged with the shaft guide member.

11. The cartridge of claim 10, further comprising:
a detector window provided on a top side of a chamber, wherein the shaft guide member is connected to the chamber below the detector window.
